(19) United States
(12) Patent Application Publication
(10) Pub. No.: US 2011/0309200 A1
(43) Pub. Date: Dec. 22, 2011

(54) Apparatus, Satellite and Method for Trapping High-Speed Particles

(75) Inventor: Ulrich Knirsch, Markdorf (DE)

(73) Assignee: Astrium GmbH, Taufkirchen (DE)

(21) Appl. No.: 13/165,109

(22) Filed: Jun. 21, 2011

(30) Foreign Application Priority Data
Jun. 22, 2010 (DE) 10 2010 024 644.1

(51) Int. Cl. B64G 4/00; B07B 1/00; B64G 1/44; B64G 1/00; G05D 1/10

(52) U.S. Cl. 244/172.7; 244/158.1; 701/13; 209/235

(57) ABSTRACT

An apparatus for trapping high-speed particles, such as space debris, is provided. The apparatus includes a first front tapping surface and at least one rear trapping surface. The front and rear trapping surfaces are arranged substantially parallel to each other and are spaced apart from each other in the normal direction.

### CROSS REFERENCE TO RELATED APPLICATION

The present application claims priority under 35 U.S.C. §119 to German Patent Application No. 10 2010 024 644.1, filed Jun. 22, 2010, the entire disclosure of which afore-mentioned document is herein expressly incorporated by reference.

### BACKGROUND AND SUMMARY OF THE INVENTION

The present invention relates to an apparatus for trapping high-speed particles, in particular space debris. It further relates to a satellite provided with such an apparatus and a method for trapping high-speed particles, in particular space debris.

Debris produced by continuous and increasing use of space endangers satellites and manned space missions. Here, the greatest danger is posed by so-called critical fragments, the size of which is between one millimeter and several centimeters. These critical fragments have the potential to break through a satellite or even the armoring of a space station; however, they are too small to be detected from Earth so that flying evasive maneuvers cannot be performed. Critical fragments appear much more frequently than larger fragments.

An article by Lappas (http://www.economist.com/science-technology/displaystory.cfm?story_id=15814490) proposes to align a solar sail of a defective satellite in such a manner that due to the radiation incident on the solar sail, the satellite is directed toward the atmosphere so as to accelerate the reentry of the satellite into the atmosphere and thus to accelerate the complete destruction of the same. During this process which, however, could drag on for several years, the solar sail is also to be used to trap microscopic fragments which move in the respective orbit. However, the disadvantage is that solar sails made of extremely thin material are destroyed upon impact of a critical fragment in such a manner that they release secondary particles, which then move in the orbit as independent critical fragments. In addition, according to this proposal, the solar sails are used for trapping space debris only after the end of the mission so that this proposal does not allow immediate removal of space debris.

Exemplary embodiments of the present invention provide an apparatus that allows efficient collection or destruction of high-speed particles, in particular critical fragments of space debris. The present invention is also directed to a satellite equipped with such an apparatus. The present invention is also directed to a method by means of which such a satellite can trap high-speed particles.

The apparatus according to the invention for trapping high-speed particles, in particular space debris, is provided with a first front trapping surface and at least one further, rear trapping surface, wherein the trapping surfaces are arranged substantially parallel to each other and are spaced apart from each other in the normal direction.

This double-layered structure of the apparatus according to the invention with the two trapping surfaces arranged parallel and spaced apart from each other has the effect that particles impinging on the first front trapping surface break through the impact point, but burst at the same time into a plurality of particles. Thereby, they form a cone of fragments that continue to fly toward the rear trapping surface. Due to the distance provided between the two trapping surfaces, these fragments spread during the impact on the rear trapping surface over a large area so that the rear trapping surface is able to collect the debris fragments remaining from the high-speed particle.

It can happen that so-called super-critical or also particularly slow particles are not sufficiently decelerated and/or fragmented when impinging on the first trapping surface so that these particles also penetrate the rear trapping surface; however, in doing so, they are sharply decelerated and are further fragmented with high probability upon impinging on the rear trapping surface so that the reentry of the still remaining and decelerated fragments into the atmosphere is accelerated and thus their potential danger as space debris is also effectively reduced.

Preferably, the front trapping surface comprises a material which has a higher inner sonic velocity than the material of the rear trapping surface. This configuration of the front surface, also referred to as “bumper”, provides for an optimal fragmentation of impinging high-speed particles with minimal dead weight.

It is advantageous here if the material of the front trapping surface has ceramically reinforced fibers. Such ceramically reinforced fibers provide particularly effectively for a fragmentation of impinging high-speed particles. The thickness of the front trapping surface plays only an insignificant role for the effectiveness; however, the front trapping surface should be thick enough that in case of a collision with a high-speed particle, it is not penetrated by the same but also ensures that the high-speed particle is fragmented by the impact.

Preferably, the rear trapping surface has a material, the elasticity of which is greater than the one of the material of the front trapping surface. The rear trapping surface, also referred to as “catcher”, must be able to catch the fragments generated during the impact of the high-speed particle on the front surface, for which reason the rear trapping surface preferably consists of a material that is more ductile than the one of the front trapping surface.

Here, the material of the rear trapping surface contains preferably aramid fibers as they are known for example under the trademark Kevlar®.

Furthermore, it is advantageous if the thickness of the rear trapping surface is greater than the thickness of the front trapping surface. While the front trapping surface serves as fragmenting layer, the rear trapping surface has to serve as trapping layer, which is facilitated in that the rear trapping surface is thicker and more elastic than the front trapping surface.

It is also possible to provide further trapping surfaces as fragmenting layer and/or as trapping layer, whereby the effect of the apparatus is further improved. However, optimization analyses have demonstrated that providing further internal trapping surfaces between the front and the rear trapping surfaces is not optimal in terms of mass because the effect of a large distance between the front and the rear trapping surfaces, which distance effects a distribution of the fragments over a larger area, is predominant. Thus, it makes more sense to invest the mass, which would include further trapping surfaces, into thickness and elasticity of the rear trapping surface. While maintaining the same mass, this results in a significantly higher efficiency during trapping high-speed particles.

It is particularly advantageous if the trapping surfaces are formed by non-rigid bodies that are each retained on two sides facing away from each other on in each case one support structure. This structure facilitates the transport of the apparatus into space.

It is advantageous if the support structure is formed in each case by a winding core body, wherein at least one of the winding core bodies is rotatable about an axis extending parallel to the spanning planes of the trapping surfaces so as to wind the trapping surfaces onto said winding core body or to wind them off the same.

This makes it possible to transport the entire apparatus in the wound state into space, wherein the trapping surfaces are optimally stowed in terms of volume so as to subsequently unwind and span them in space.

Particularly advantageous is a further development of this embodiment, wherein both winding core bodies are rotatable in each case about an axis extending parallel to the spanning planes of the trapping surfaces so as to wind the trapping surfaces onto both winding core bodies or to wind them off the same, wherein the axes of the two winding core bodies preferably extend parallel to each other. In this embodiment, the trapping surfaces can be wound prior to the start like an old scroll onto the two winding core bodies for a space-saving transport into space and can be unwound and spanned again in space.

A satellite is provided with at least one apparatus according to the invention for trapping high-speed particles. The apparatus according to the invention can either be provided on a satellite or the apparatus itself can be configured as satellite.

It is of advantage here if the navigation device, the communication device and the control computer of the satellite are provided in the support structure and if the support structure is provided with control devices for position controlling the satellite. In this embodiment, the essential energy supply and control devices are provided in the support structure, for example in one or in both of the winding core bodies, so that the entire apparatus forms a satellite.

Preferably, the support structure is provided with solar cells for energy supply which, in the unwound state of the trapping surfaces, are exposed to solar radiation. This allows carrying along only a small energy storage during take-off, which is sufficient to ensure the unwind and spanning process of the apparatus. As soon as the trapping surfaces are wound off the winding core bodies, the solar cells, which can be aligned independent of the position of the satellite, are exposed to solar radiation and are able to supply the electric energy required for the operation of the satellite.

It is particularly advantageous if the satellite according to the invention is provided with at least one support structure formed by a winding core body and if said winding core body is provided with at least one drive unit configured so as to be able to rotate the winding core body about its longitudinal axis. This drive unit can serve for carrying out the process of unwinding the trapping surfaces from the winding core body.

It is advantageous if the drive unit is formed by at least one magnetorquer and/or at least one thrust nozzle. In particular if two magnetorquer which repel each other are provided in each case in one of the two winding core bodies, the unwinding process of the two trapping surfaces wound up on both winding core bodies can be carried out in a simple manner.

The method according to the invention for trapping high-speed particles, in particular space debris, with a satellite equipped according to the invention involves the satellite moving along a flight path in a preferably common orbit with the high-speed particles to be trapped, preferably in a direction opposite to the moving direction of the high-speed particles, wherein the satellite is aligned in such a manner that the flight path extends in a direction normal to the front trapping surface. In this manner, a maximum trapping effect can be achieved with the lowest possible mass because the layers are spanned between the two support structures of the apparatus and are aligned perpendicular to the flight direction of the expected approaching high-speed particles. Thus, the flight direction of the satellite should be aligned parallel but opposite to the flight direction of the suspected space debris particles.

This is achieved by a gravitational stabilization of the satellite. The total mass of the satellite is determined to a large extent by the two end bodies formed by the support structures or winding core bodies. These two end bodies are connected to each other by the trapping surfaces which consist, for example, of a fabric layer and are forced in this manner to the same angular velocity. For the mass of the end body located radially outwardly with respect to the orbit, this angular velocity is thus slightly too high so that the centrifugal force predominates over the gravitational force. Thus, the mass of this end body is drawn outwardly. In case of the mass of the radially inner end body, it is the other way round; accordingly, the mass is drawn downwardly, hence toward the Earth. Thus, both end bodies span the trapping surfaces without further influence and align the same in an optimal manner. It should be considered here that the length L of the trapping surfaces, thus their extension between the two end bodies is significantly greater than the width B of the trapping surfaces. Moreover, the width B is limited by the payload cover of the launching rocket. In practice, values of W=4 m and 1=40 m have proved to be suitable.

Reference numbers in the claims, the description and the drawings serve only for a better understanding of the invention and are not intended to limit the scope of the protection.

Other objects, advantages and novel features of the present invention will become apparent from the following detailed description of one or more preferred embodiments when considered in conjunction with the accompanying drawings.

### BRIEF DESCRIPTION OF THE DRAWINGS

In the figures:

FIG. 1 shows a schematic perspective view of an apparatus according to the invention; and

FIGS. 2A and FIG. 2B show the principle of operation of the two trapping surfaces during the impact of a high-speed particle

### DETAILED DESCRIPTION

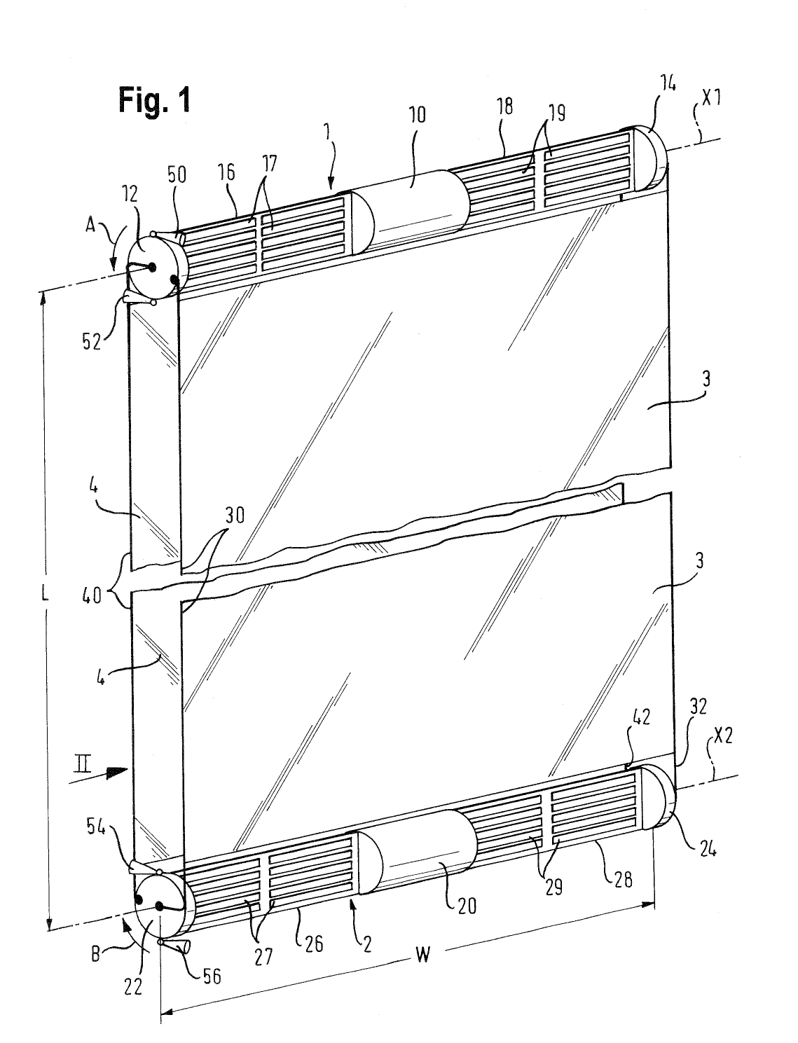

FIG. 1 schematically illustrates an apparatus for trapping high-speed particles according to the invention. This apparatus has a first winding core body 1, a second winding core body 2, a front trapping surface 3 and a rear trapping surface 4. The two trapping surfaces 3, 4 are formed by non-rigid bodies and consist for example of a fabric web or foil web. The winding core bodies 1, 2 are forced in opposite directions by mechanisms yet to be defined in more detail so that the trapping surfaces 3, 4 are spanned between the two winding core bodies 1, 2. In this manner, the winding core bodies 1, 2 each form one support structure for the apparatus.

Each of the two trapping surfaces 3, 4 is provided at its sides with a tensioning cable 30, 32, 40, 42 fastened with one end to the first winding core body and with the other end to the winding core body 2. The respective trapping surface 3, 4 thus extends in transverse direction between the associated tensioning cables 30, 32 and 40, 42, respectively. The ends of the respective tensioning cables 30, 32, 40, 42 protrude beyond the upper and, respectively, lower edge of the trapping surface 3, 4 so that the trapping surface 3, 4 in the expanded state of the apparatus shown in FIG. 1 does not cover the winding core bodies 1, 2.

The respective winding core body 1, 2 has a cylindrical central element 10, 20 formed as closed housing body. On both lateral ends, each winding core body 1, 2 is provided with an end disk 12, 14, 22, 24. A carrier plate 16, 18 and 26, 28, respectively, extends in each case between the central body 10, 20 and the end disks 12, 14 and 22, 24, respectively, which carrier plate is provided with solar cells 17, 19, 27, 29 on one or on both surfaces extending between the central body 10, 20 and the associated end plate 12, 14, 22, 24.

The disk-like end bodies 12, 14, 22, 24 are formed as winding spools onto which the tensioning cables 30, 32, 40, 42 of the trapping surfaces 3, 4 can be wound. The central cylindrical central element 10, 20 has substantially the same outer diameter as the associated end disks 21, 14, 22, 24 so that the end disks and the central element of the respective winding core body 1, 2 serve for guiding and supporting the fabric or foil web of the respective trapping surface 3, 4 when the same is being wound onto the respective winding core body 1, 2.

In the example shown in FIG. 1, the apparatus itself is configured as satellite, wherein the central elements 10, 20 receive sub-systems, thus operational components of the satellite, for example a navigation device, a communication device, a control computer and an energy storage. Moreover, in each of the two central elements 10, 20, a magnetorquer is provided which is arranged parallel to the rotation axis X1, X2 of the respective winding core body 1, 2. Each of these magnetorquers generates a magnetic field, wherein the magnetic field of the first magnetorquer and the magnetic field of the second magnetorquer are oriented in opposite directions so that the mutual influence of the two magnetic fields results in that the magnetorquers and thus the two winding core bodies 1, 2 rotate in opposite directions with respect to each other about the respective axis X1, X2, as symbolically indicated by the two arrows A, B. The rotational direction shown by the arrows A, B ensures that the two trapping surfaces 3, 4 are wound onto the winding core bodies 1, 2. However, the magnetorquers can also be operated in such a manner that the winding core bodies 1, 2 rotate in the opposite direction of the arrows A, B so as to thereby wind the trapping surface 3, 4 off the winding core bodies 1, 2.

Furthermore, control nozzles 50, 52, 54, 56 configured as thrust nozzles are arranged at least on the end disks 12, 22 on one side of the apparatus on places diametrically facing away from each other in the region of the edge of the respective end disk 12, 22, by means of which control nozzles, a position control of the satellite can be carried out. The control nozzles 50, 52 and 54, 56, respectively, of an end disk 12, 22 are each tangent to the circumference and directed in opposite directions. Moreover, the control nozzles 50, 52, 54, 56 are arranged such that they are able to rotatably drive the winding core bodies 1, 2 assigned to said control nozzles in opposite directions, thus in the direction of the arrows A, B so as to be able to wind the trapping surfaces 3, 4 onto the winding bodies 1, 2. Although in the illustration of FIG. 1, the control nozzles are provided only on one end of the respective winding core body 1, 2, it is of course also possible that corresponding control nozzles are also provided in the same manner on the other end.

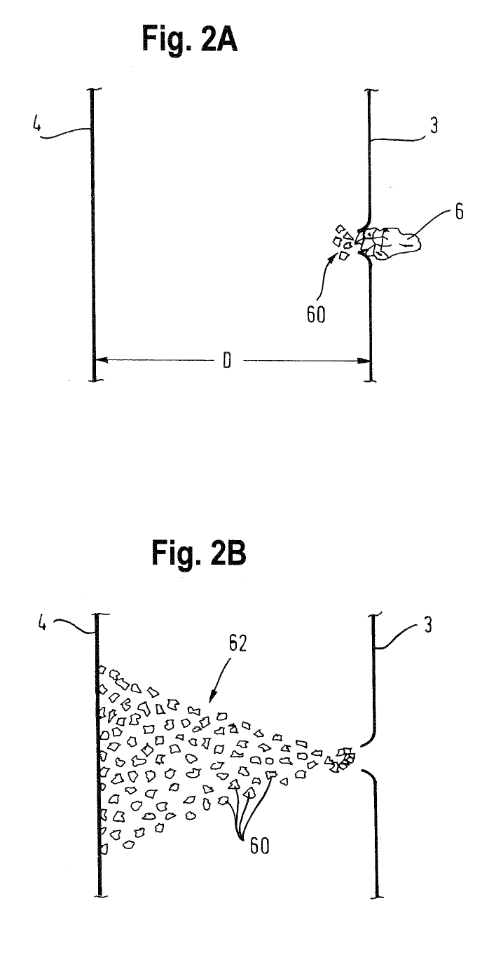

FIG. 2A shows a side view of a detail of the apparatus according to the invention of FIG. 1 in the direction of arrow II at the moment of the impact of a high-speed particle 6 on the front trapping surface 3. It is shown here that the particle 6 locally penetrates the trapping surface 3 and breaks into pieces during this collision with the trapping surface 3. By this impact, the kinetic energy of the particles 6 is reduced; however, the particle's 6 fragments 60 generated during the impact have still enough energy to continue to fly toward the rear trapping surface 4.

By the impact and the associated bursting of the particle 6 into fragments 60, a fragment cone 62 is generated behind the front trapping surface 3, as shown in FIG. 2B. The fragments which are decelerated with respect to the original speed of the particle 6 and the mass of which is significantly lower than the mass of the original particle 6 thus each have a significantly lower kinetic energy than the particle 6 had prior to the impact on the front trapping surface 3. Moreover, by the creation of the fragment cone, the impact area of the fragments on the second trapping surface 4 becomes larger compared to the impact area of the particle 6 on the first trapping surface 3. The respective fragment 60 thus exerts a significantly lower impact effect on the second trapping surface 4 than the one exerted by the particle 6 on the first trapping surface 3. Since, in addition, the second trapping surface 4 consists of a material, the elasticity of which is higher than the one of the material of the front trapping surface 3, and since the rear trapping surface 4 is thicker than the front trapping surface 3, the fragments 60 are trapped by the rear trapping surface 4 without breaking through the same.

To ensure an effective expansion of the fragment cone 62 of the fragments 60 until they impact on the rear trapping surface 4 it has proved to be useful if the distance D between the two trapping surfaces 3, 4 has a dimension of approximately 50 cm. Consequently, the diameter of the end disks 12, 14, 22, 24 is also approximately 50 cm. This dimension represents an acceptable compromise between the payload volume to be provided in a launch vehicle and the desired maximization of the distance between the two trapping surfaces 3, 4.

The protective effect of the apparatus according to the invention (defined as maximum size of trapped particles) is largely determined by the square of the distance D between the two trapping surfaces 3, 4. A design example for an apparatus according to the invention configured as satellite has a width of W=4 m and a length of L=40 m between the two axes of the winding core bodies 1, 2 and a distance between the two trapping surfaces of D=0.5 m.

Due to the high ratio of surface to mass, an apparatus according to the invention configured as satellite in a near-Earth orbit in which the space debris is to be trapped is relatively sharply decelerated by the residual atmosphere of the Earth still present there. This deceleration process ensures that the apparatus configured as satellite behaves in conformity with the space debris guidelines; this means that this satellite reenters the atmosphere automatically and timely.

This satellite can be used in two different ways:

a) Preventive

The satellite is launched and sent into orbit where the probability of collision with high-speed particles (space debris) is high. This applies in particular in case of sun-synchronous low orbits.

b) Reactive

The satellite is not launched before a high fragmentation took place in an orbit, for example due to an explosion of a satellite or a collision between two satellites. The particles resulting from said fragmentation will still be concentrated in the first days after the collision in the two nodes of the orbit of the collided satellite. One of the nodes is the location at which the collision or explosion took place; the other one lies on the side opposite thereto with respect to the Earth. Thus, in case of this reactive strategy, the satellite according to the invention for trapping high-speed particles is to be sent into an orbit that has a high probability of presence near a node. Suitable in this connection are for example eccentric orbits, comparable to Molniya orbits.

With the apparatus according to the invention, in particular if the apparatus is configured as independent satellite, efficient trapping or destroying and decelerating of critical space debris particles is possible through a high ratio of surface area to mass. Furthermore, the satellite shown in the figures and described in the example is constructed in a simple and cost-effective manner. The high ratio of surface area to mass provides in addition for an automatic reentry of the satellite into the atmosphere.

The invention is not limited to the exemplary embodiment above which merely serves for general illustration of the central idea of the invention. In fact, within the context of the scope of the protection, the apparatus according to the invention can also be configured in embodiments which are different from the ones described above. The apparatus can comprise in particular features which represent a combination of the respective individual features of the claims.

Reference numbers in the claims, the description and the drawings serve only for a better understanding of the invention and are not intended to limit the scope of the protection.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE LIST

### Referenced are:

1 Winding core body

2 Winding core body

3 Front trapping surface

4 Rear trapping surface

6 High-speed particles

10 Central body

12 End disk

14 End disk

16 Carrier plate

17 Solar cells

18 Carrier plate

19 Solar cells

20 Central body

22 End disk

24 End disk

26 Carrier plate

27 Solar cells

28 Carrier plate

29 Solar cells

30 Tensioning cable

32 Tensioning cable

40 Tensioning cable

42 Tensioning cable

50 Control nozzles

52 Control nozzles

54 Control nozzles

56 Control nozzles

60 Fragments

62 Fragments

X1 Rotation axis

X2 Rotation axis

What is claimed is:

1. An apparatus for trapping high-speed particles, comprising:
a first front trapping surface; and
a rear trapping surface,
wherein the front and rear trapping surfaces are arranged substantially parallel to each other and are spaced apart from each other in a normal direction.

2. The apparatus according to claim 1, wherein the front tapping surface comprises a material with a higher inner sonic velocity than a material of the rear trapping surface.

3. The apparatus according to claim 2, wherein the material of the front trapping surface comprises ceramically reinforced fibers.

4. The apparatus according to claim 2, wherein the material of the rear trapping surface has an elasticity that is greater than an elasticity of the material of the front trapping surface.

5. The apparatus according to claim 4, wherein the material of the rear trapping surface includes aramid fibers.

6. The apparatus according to claim 1, wherein a thickness of the rear trapping surface is greater than a thickness of the front trapping surface.

7. The apparatus according to claim 1, wherein the front and rear trapping surfaces are non-rigid bodies that are each retained on two sides facing away from each other on a respective support structure.

8. The apparatus according to claim 7, wherein the respective support structure includes a winding core body, wherein at least one of the winding core bodies is rotatable about an axis extending parallel to spanning planes of the front and rear trapping surfaces so as to wind the front and rear trapping surfaces onto the winding core body or to wind them off the winding core body.

9. The apparatus according to claim 8, wherein both winding core bodies are rotatable about an axis extending parallel to the spanning planes of the front and rear trapping surfaces so as to wind the trapping surfaces onto both winding core bodies or to wind them off both winding core bodies, wherein the axes of the two winding core bodies extend parallel to each other.

10. A satellite comprising:
an apparatus for trapping high-speed particles, the apparatus comprising
a first front trapping surface; and
a rear trapping surface,
wherein the front and rear trapping surfaces are arranged substantially parallel to each other and are spaced apart from each other in a normal direction.

11. The satellite according to claim 10, wherein a navigation device, a communication device and a control computer of the satellite are provided in a support structure and the support structure is provided with control devices for position controlling the satellite.

12. The satellite according to claim 10, comprising a support structure provided with solar cells for energy supply which, in the unwound state of the front and rear trapping surfaces, are exposed to solar radiation.

13. The satellite according to claim 10, comprising at least one support structure formed by a winding core body, wherein the winding core body includes at least one drive unit configured to rotate the winding core body about its longitudinal axis.

14. The satellite according to claim 13, wherein the drive unit is at least one magnetorquer or at least one thrust nozzle.

15. A method for trapping high-speed particles using a satellite with an apparatus for trapping high-speed particles that includes a first front trapping surface and a rear trapping surface, the front and rear trapping surfaces being arranged substantially parallel to each other and are spaced apart from each other in a normal direction, wherein the satellite moves along a flight path in a common orbit with the high-speed particles to be trapped, in a direction opposite to a moving direction of the high-speed particles, wherein the satellite is aligned in such a manner that the flight path extends in a direction normal to the front trapping surface.
